(19) United States
(12) Patent Application Publication
(10) Pub. No.: US 2020/0250738 A1
(43) Pub. Date: Aug. 6, 2020

(54) SHOPPING GUIDE METHOD AND SHOPPING GUIDE PLATFORM

(71) Applicants: INDUSTRIAL TECHNOLOGY RESEARCH INSTITUTE, Hsinchu (TW); Intellectual Property Innovation Corporation, Hsinchu (TW)

(72) Inventors: Te-Chih LIU, Taoyuan City (TW); Ting-Hsun CHENG, Shuishang Township (TW); Chih-Chia CHANG, Zhubei City (TW); Yu-Hsin LIN, Toufen City (TW)

(73) Assignees: INDUSTRIAL TECHNOLOGY RESEARCH INSTITUTE, Hsinchu (TW); Intellectual Property Innovation Corporation, Hsinchu (TW)

(21) Appl. No.: 16/406,822

(22) Filed: May 8, 2019

(30) Foreign Application Priority Data
Feb. 1, 2019 (TW) 108104072

(51) Int. Cl. G06Q 30/06; H04W 4/024; H04W 4/33; H04B 17/318; H04W 4/80; G06K 9/00; G06T 7/73

(52) U.S. Cl. CPC G06Q 30/0639; H04W 4/024; H04W 4/33; G06Q 30/0625; H04W 4/80; G06K 9/00771; G06T 7/73; H04B 17/318

(57) ABSTRACT

A shopping guide method and a shopping guide platform are provided. The shopping guide method includes steps of: receiving object search information, searching a database according to the object search information to determine a needed object, obtaining object location information of the needed object according to the needed object, and obtaining object guiding information according to the object location information, wherein the object guiding information includes an in-store guiding route.

This application claims the benefit of Taiwan application Serial No. 108104072, filed Feb. 1, 2019, the disclosure of which is incorporated by reference herein in its entirety.

### TECHNICAL FIELD

The disclosure relates to a shopping guide method and a shopping guide platform.

### BACKGROUND

Consumers usually wish to quickly obtain needed objects when doing shopping. However, stores may contain numerous types of objects and be spacious, and display information and labels of objects may also be in disorder and unclear, in a way that consumers cannot easily find desired objects. According to statistics, there are 70 percent of individuals that would inquire the whereabouts of desired objects.

Search results of current shopping platform are capable of providing object information of online stores but cannot directly guide consumers to display locations of physical stores.

### SUMMARY

A shopping guide method is provided according to an embodiment of the disclosure. The shopping guide method include steps of: receiving object search information, searching a database according to the object search information to determine a needed object, obtaining object location information of the needed object according to the needed object, and obtaining object guiding information according to the object location information, wherein the object guiding information includes an in-store guiding route.

A shopping guide platform is provided according to an embodiment of the disclosure. The shopping guide platform includes a platform transmission unit, a database, a search unit and a route unit. The platform transmission unit receives object search information from a mobile device. The search unit searches the database according to the object search information to determine a needed object, and obtains object location information of the needed object according to the needed object. The route unit obtains object guiding information according to the object location information, wherein the object guiding information includes an in-store guiding route.

To better understand the disclosure, embodiments are described in detail with the accompanying drawings below.

### BRIEF DESCRIPTION OF THE DRAWINGS

FIG. 1 is a schematic diagram of a shopping guide platform and a mobile device according to an embodiment;

FIG. 2 is a flowchart of an offline procedure of a shopping guide method according to an embodiment;

FIG. 3 is a schematic diagram of a display area of an object according to an embodiment;

FIGS. 4A to 4D are flowcharts of an online procedure of a shopping guide method according to an embodiment;

FIG. 5 is a schematic diagram of object search information according to an embodiment;

FIG. 6 is a schematic diagram of a shopping guide platform and a shopping guide method applied to another field; and

FIG. 7 is a schematic diagram of a shopping guide platform and a shopping guide method applied to another field.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Various embodiments of a shopping guide method and a shopping guide platform are disclosed below. In the disclosure, a user can use, for example, an image recognition technology and a position system to provide a shopping guiding route, allowing the user to quickly find a needed object in a store. The store is, for example, a mart, a food court or a parking lot, and the needed object is, for example, a merchandise, a seat or a parking space. The disclosure is not limited to the above examples.

A shopping guide method according to an embodiment of the disclosure includes an offline procedure and an online procedure. The offline procedure is for establishing a database. The online procedure is for shopping guidance. The offline procedure is first described below.

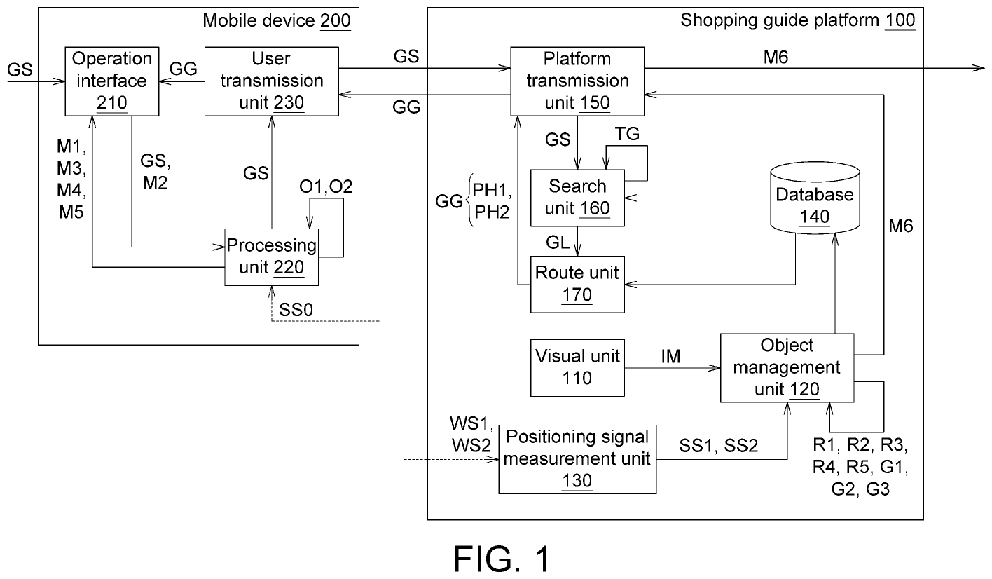

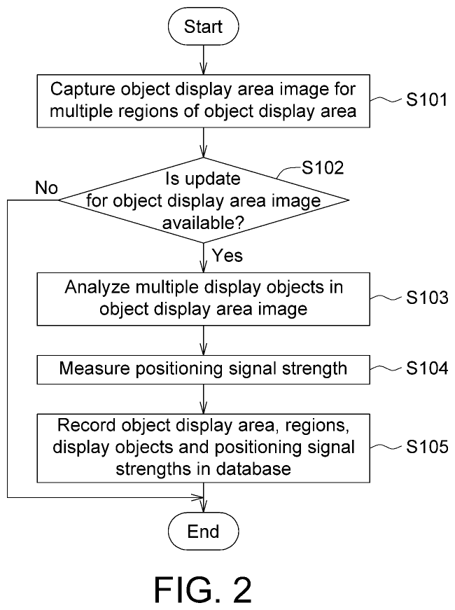

Refer to FIG. 1 and FIG. 2. FIG. 1 shows a schematic diagram of a shopping guide platform 100 and a mobile device according to an embodiment. FIG. 2 shows a flowchart of an offline procedure of a shopping guide method according to an embodiment. The shopping guide platform 100 is, for example, a cloud server, a computer, a cluster computing system or an edge cloud computing system. The mobile device 200 is, for example, a smartphone, a tablet computer, a personal computer or a smart home appliance. Multiple mobile devices 200 can simultaneously communicate with the shopping guide platform 100. In FIG. 1, only one mobile device 200 is depicted as an example rather than a limitation to the disclosure.

The shopping guide platform 100 includes at least one visual unit 110, an object management unit 120, a positioning signal measurement unit 130, a database 140, a platform transmission unit 150, a search unit 160 and a route unit 170. The visual unit 110 is, for example, a camera, a video camera, or an electronic apparatus having an image capturing device. The positioning signal measurement unit 130 is, for example, a wireless network receiver or a Bluetooth signal receiver. The platform transmission unit 150 is, for example, wired network transmission device or a wireless network transmission device. The object management unit 120, the search unit 160 and the route unit 170 are, for example, a circuit, a chip, a circuit board, or a storage device storing multiple program codes. Operation details of the components are given with the flowcharts below.

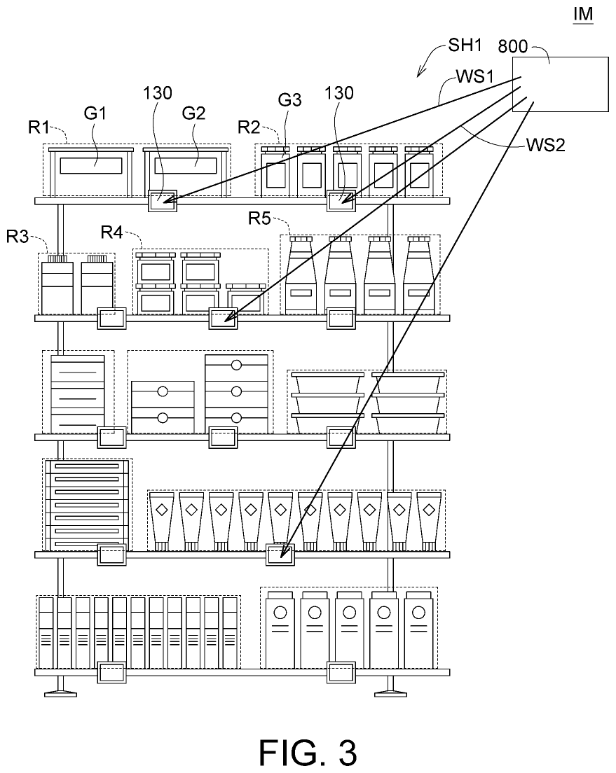

In one embodiment, the store is, for example, a mart, and the needed object is, for example, a merchandise. Refer to FIG. 3 showing a schematic diagram of an object display area SH1 according to an embodiment. The object display area SH1 is, for example, a shelf. In step S101 in FIG. 2, the visual unit 110 captures an object display area image IM for multiple regions R1, R2, R3, R4, R5, . . . of the object display area SH1. The visual unit 110 is mounted before the object display area SH1. The object display area image IM is, for example, contents shown in FIG. 3. The object display area SH1 can be divided into multiple regions R1, R2, R3, R4, R5, . . . , which can be divided in advance by a manager or be divided by the object management unit 120 using an algorithm. In one embodiment, because the visual unit 110 can be fixed mounted, the division of the regions R1, R2, R3, R4, R5, . . . does not need to be repeatedly performed each time the object display area image IM is captured. The division of the regions R1, R2, R3, R4, R5, . . . is performed according to similarity of objects, according to a predetermined length, or by means of an average. In one embodiment, the sizes of the regions R1, R2, R3, R4, R5, . . . can be different.

In step S102, the object management unit 120 can determine whether an update for the object display area image IM is available. If there is no update for the object display area image IM and the object display area image IM is identical to the previously analyzed contents, no subsequent processing needs to be performed.

If an update for the object display area image IM is available, in step S103, the object management unit 120 can analyze at least one display object G1, G2, G3 . . . in the object display area image IM. The object management unit 120 can first separate individual objects by using an object segmentation algorithm, and then compare the individual objects with the corresponding display objects G1, G2, G3 . . . by using an image comparison algorithm.

Next, in step S104, the positioning signal measurement unit 130 measures positioning signal strengths SS1, SS2, . . . . The positioning signal measurement unit 130 can be mounted on the object display area SH1, and receives wireless signals WS1, WS2, . . . from a wireless signal transmitter 800 at a distal location. The positioning signal strengths SS1, SS2 . . . of the wireless signals WS1, WS2, . . . vary as the distance between the positioning signal measurement unit 130 and the wireless signal transmitter 800 differ. Therefore, different positioning signal strengths SS1, SS2, . . . can represent different locations. In one embodiment, a positioning signal measurement unit 130 can be allocated to each of the regions R1, R2, R3, R4, R5, . . . . For example, the region R1 corresponds to the positioning signal strength SS1, the region R2 corresponds to the positioning signal strength SS2, and so forth. Alternatively, in one embodiment, one positioning signal measurement unit 130 can be allocated to multiple neighboring regions R1, R2, R3, R4, R5 . . . .

In step S105, the object management unit 120 can record the object display area SH1, the regions R1, R2, R3, R4, R5, . . . , the display objects G1, G2, G3, . . . and the positioning signal strengths SS1, SS2, . . . in the database 140. For example, referring to Table-1 below, the object management unit 120 can record the relationship of the object display area SH1, the region R1 and the positioning signal strength SS1 in a mapping table.

TABLE 1

| Display | Object display | | Positioning |
|---|---|---|---|
| object | area | Region | signal strength |
| G1 | SH1 | R1 | SS1 |
| G2 | SH1 | R1 | SS1 |
| G3 | SH1 | R2 | SS2 |

With the above offline procedure of the shopping guide method, data of the display objects G1, G2, G3, . . . can be established. A combination of the object display area SH1 and the regions R1, R2, R3, R4, R5, . . . represents object location information GL of the display objects G1, G2, G3, . . . . When a user wishes to do shopping, by determining through comparison a certain display object G1, G2, G3, . . . , the object location information GL can be quickly given and navigation can be performed by using the positioning signal strengths SS1, SS2, . . . . Details of using the online procedure of the shopping guide method to quickly perform navigation are given below.

As shown in FIG. 1, a user can use an application installed in the mobile device 200 to communicate with the shopping guide platform 100. The mobile device 200 can include an operation interface 210, a processing unit 220 and a user transmission unit 230. The operation interface 210 is, for example, a touch screen. The processing unit 220 is, for example, a circuit, a chip, a circuit board or a storage device storing multiple program codes. The user transmission unit 230 is, for example, a wired transmission device or a wireless transmission device.

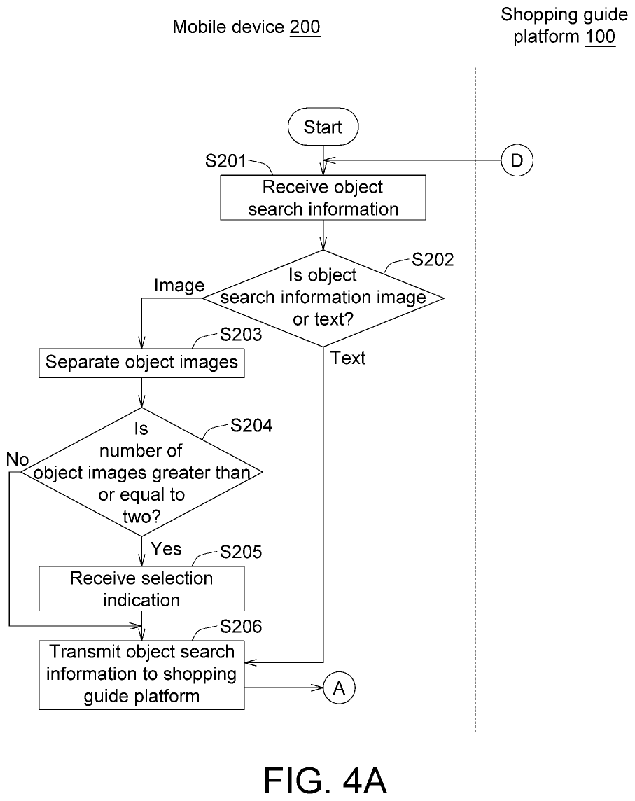

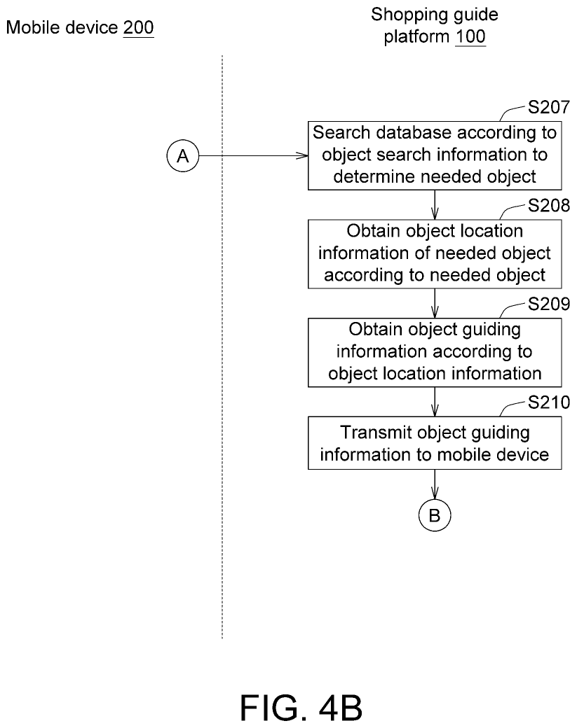

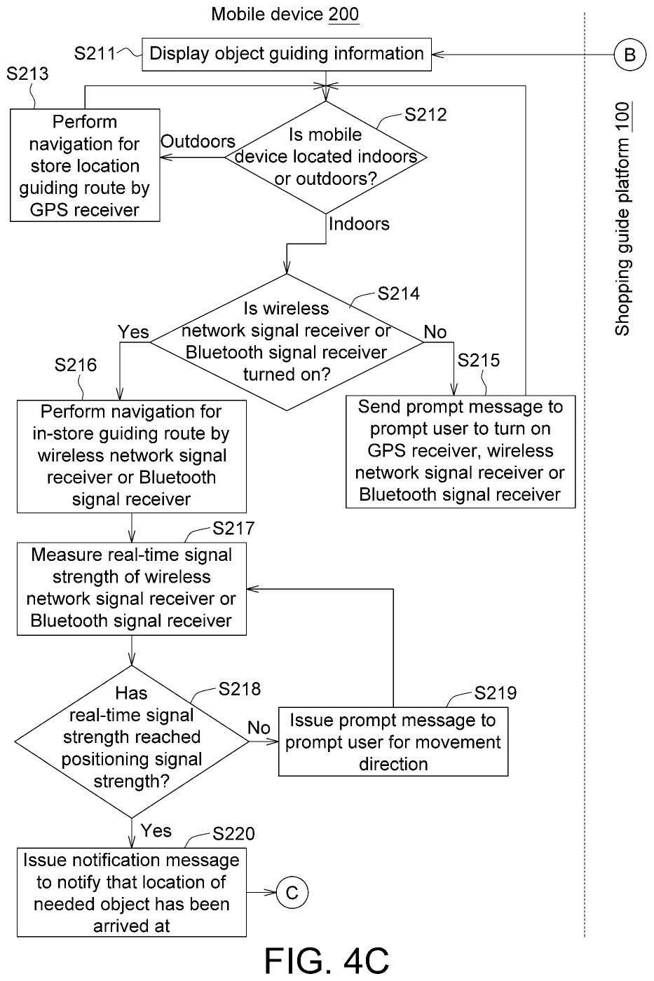

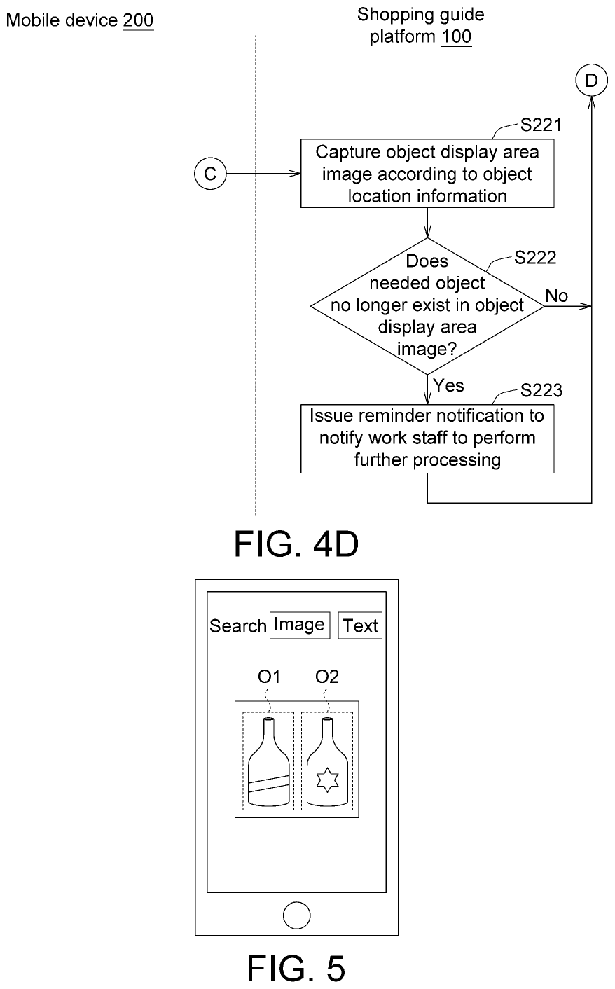

Refer to FIGS. 4A to 4D showing flowcharts of an online procedure of a shopping guide method according to an embodiment. In step S201, the operation interface 210 receives object search information GS. Refer to FIG. 5 showing a schematic diagram of the object search information GS according to an embodiment. The operation interface 210 can display, for example, a button of “image” and/or “text” for the user to choose from so as to perform search on the basis of an image or text. An application scenario is, for example, for a tasty beverage enjoyed in a restaurant, a photograph of the drink can be directly taken and be used for searching to find locations from which the drink can be purchased. Alternatively, a user can directly enter text such as the name of an object or a barcode of an object for searching.

Next, in step S202, the processing unit 220 identifies whether the object search information GS entered is an image or text. If the object search information GS is an image, step S203 is performed; if the object search information GS is text, step S206 is performed.

In step S203, the processing unit 220 separates at least one object image O1 and O2 according to the object search information GS. As shown in FIG. 5, the processing unit 220 discovers, after analyzing by means of an object segmentation algorithm, that the image captured may contain multiple object images O1 and O2.

Next, in step S204, the processing unit 220 determines whether the number of the object images is greater than or equal to two. If the number of object images is greater than or equal to two, step S205 is performed; if the number of object images is not greater than or equal to two, step S206 is performed.

In step S205, the processing unit 220 issues an inquiry message M1 by using the operation interface 210 to inquire the user whether the user wishes to search for the image object O1 or O2, and a selection indication M2 is received in this step. After the selection indication M2 is received, the content of the selected object search information GS can be determined. Alternatively, in another embodiment, a user can separate an object image by using the operation interface 210 in step S203, and steps S204 and S205 can thus be omitted.

In step S206, the user transmission unit 230 transmits the object search information GS to the platform transmission unit 150 of the shopping guide platform 100.

Then, in step S207, the search unit 160 of the shopping guide platform 100 searches the database 140 according to the object search information GS to determine a needed object TG. In this step, if the object search information GS is text, a mapping table in the database 140 can be searched to look up a display object (e.g., a display object G1, G2 or G3 . . . ) having similar or the same description as the object search information GS, as the needed object TG. If the object search information GS is an image, image comparison can be performed to determine a display object (e.g., a display object G1, G2 or G3 . . . ) having similar or the same image feature as the object search information GS, as the needed object TG. In one embodiment, the search unit 160 can provide at least one similar needed object TG for a user to choose from, and the similar needed object TG selected can then serve as the needed object TG according to the user selection.

Next, in step S208, the search unit 160 obtains object location information GL of the needed object TG according to the needed object TG. The object location information GL is, for example, a combination of the object display area SH1 . . . and the regions R1, R2, R3, R4, R5, . . . . In addition to representing the location of the store, the object location information GL further includes an in-store object display location.

Then, in step S209, the route unit 170 obtains object guiding information GG according to the object location information GL. The object guiding information GG is, for example, a combination of a store location guiding route PH1 and an in-store guiding route PH2. The store location guiding route PH1 is for guiding to an address of the store, and the in-store guiding route PH2 is for guiding to the regions R1, R2, R3, R4, R5, . . . of the object display area SH1. In one embodiment, the route unit 170 can also provide multiple store location guiding routes PH1 for a user to choose from, or can provide multiple in-store guiding routes PH2 for a user to choose from.

Next, in step S210, the platform transmission unit 150 transmits the object guiding information GG to the user transmission unit 230 of the mobile device 200.

Then, in step S211, the object guiding information GG displayed by the operation interface 210 can include the store location guiding route PH1 and the in-store guiding route PH2.

Next, in step S212, the processing unit 220 determines whether the mobile device 200 is located indoors or outdoors. If it is determined that the mobile device 200 is located outdoors, step S213 is performed; if it is determined that the mobile device 200 is located indoors, step S214 is performed. In one embodiment, the processing unit 220 can turn on, for example, a GPS receiver, and determine whether a GPS signal is received therefrom to determine whether the mobile device 200 is located outdoors. If the GPS receiver is turned on and the GPS signal is received, it is determined that the mobile device 200 is located outdoors; if the GPS receiver is turned on but the GPS signal is not received, it is determined that the mobile device 200 is located indoors.

In step S213, the processing unit 220 performs navigation for the store location guiding route PH1 by using the GPS receiver.

In step S214, the processing unit 220 determines whether a wireless network signal receiver or a Bluetooth signal receiver of the mobile device 200 is turned on. Step S215 is performed if not, otherwise step S216 is performed if so.

In step S215, because none of the GPS receiver, the wireless network signal receiver and the Bluetooth signal receiver is turned on, the processing unit 220 sends a prompt message M3 to prompt the user to turn on the GPS receiver, the wireless network signal receiver or the Bluetooth signal receiver.

In step S216, the processing unit 220 performs navigation for the in-store guiding route PH2 by using the network signal receiver or the Bluetooth receiver. That is to say, given the wireless network receiver or the Bluetooth signal receiver is turned on, navigation for the in-store guiding route PH2 can be directly performed.

In step S217, the processing unit 220 measures a real-time signal strength SS0 of the wireless network signal receiver or the Bluetooth signal receiver.

Then, in step S218, the processing unit 220 can determine whether the real-time signal strength SS0 has reached the positioning signal strength (e.g., the positioning signal strength SS1, SS2, . . . ) corresponding to the object location information GL. If the real-time signal strength SS0 has not yet reached the positioning signal strength (e.g., the positioning signal strength SS1, SS2, . . . ) corresponding to the object location information GL, step S219 is performed; if the real-time signal strength SS0 has reached the positioning signal strength (e.g., the positioning signal strength SS1, SS2, . . . ) corresponding to the object location information GL, step S220 is performed.

In step S219, the processing unit 220 issues a prompt message M4 to prompt the user for a movement direction.

In step S220, the processing unit 220 issues a notification message M5 notify the user that the user has arrived at the location of the needed object TG.

With the above method, the user can be successfully guided to the object display area SH1 and the regions R1, R2, R3, R4, R5, . . . where the needed object TG is located. Next, the shopping guide platform 100 can further determine whether the user has taken the needed object TG and whether further processing needs to be performed.

In step S221, the visual unit 110 of the shopping guide platform 100 can capture an object display area image IM according to the object location information GL.

Then, in step S222, the object management unit 120 determines whether the needed object TG no longer exists in the object display area image IM. If the needed object TG no longer exists in the object display area image IM, step S223 is performed; if the needed object TG still exists in the object display area image IM, step S201 is iterated.

In step S223, the needed object TG no longer exists in the object display area SH1, and the object management unit 120 issues a reminder notification M6 to notify work staff to perform further processing.

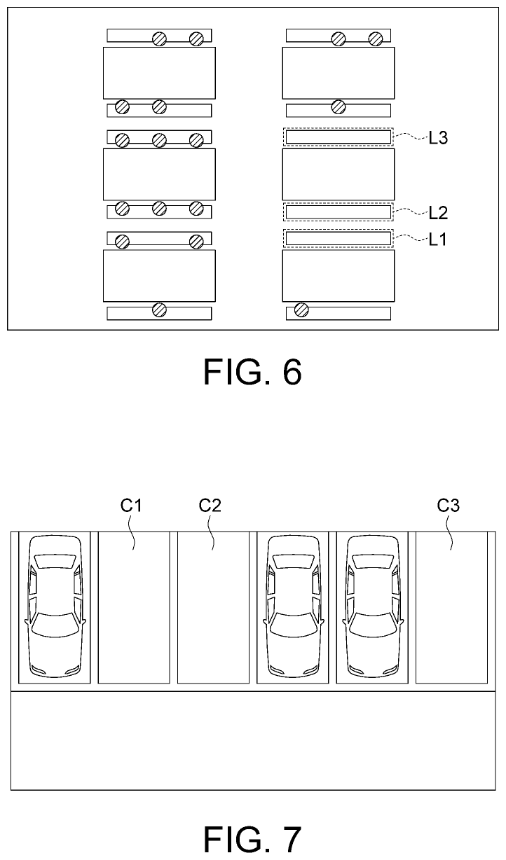

Refer to FIG. 6 showing a schematic diagram of the shopping guide platform 100 and the shopping guide method applied to another field. In one embodiment, the shopping guide platform 100 and the shopping guide method can also be applied to seats L1, L2, L3, . . . in a food court or a shop, wherein the food court or shop can be regarded as the stored above, and the seats L1, L2, L3, . . . in the food court or shop can be regarded as the objects above. Similarly, a user can be provided with a seat guiding route by using an image recognition technology and a position system, allowing the user to quickly find a needed seat in the food court or shop, and facilitating the user to shop in or near the food court or the shop.

Refer to FIG. 7 showing a schematic diagram of the shopping guide platform 100 and the shopping guide method applied to another field. In one embodiment, the shopping guide platform 100 and the shopping guide method can also be applied to parking spaces C1, C2, C3, . . . in a parking lot, wherein the parking lot can be regarded as the store above, and the parking spaces C1, C2, C2, . . . can be regarded as the objects above. Similarly, a user can be provided with a parking space guiding route by using an image recognition technology and a position system, allowing the user to quickly find a needed parking space in the parking lot.

According to the various embodiments above, the shopping guide method and the shopping guide platform 100 can provide a shopping guiding route by using an image recognition technology and a positioning system, allowing a user to quickly find a needed object in a store. Further, in the event that the object is out of inventory, a notification can be given in real time, providing more efficient object management.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A shopping guide method, comprising:
receiving, by a network transmission device, object search information;
searching a database according to the object search information to determine a needed object;
obtaining object location information of the needed object according to the needed object;
obtaining object guiding information according to the object location information, wherein the object guiding information is a combination of an in-store guiding route and a store location guiding route, the store location guiding route is for guiding to an address of a store selling the needed object, and the in-store guiding route is for guiding to a region of an object display area where the needed object is located;
measuring a real-time signal strength of a wireless network signal receiver or a Bluetooth signal receiver; and
notifying that the region of the object display area where the needed object is located has been arrived when the real-time signal strength has reached a positioning signal strength corresponding to the needed object.

2. The shopping guide method according to claim 1, wherein the object search information is an image or text.

3. The shopping guide method according to claim 1, wherein the object search information is an image, and the shopping guide method further comprises:
separating at least one object image according to the object search information; and
receiving a selection instruction if a number of the at least one object image is greater than or equal to two.

4. (canceled)

5. (canceled)

6. The shopping guide method according to claim 1, further comprising:
performing navigation for the store location guiding route by using a GPS receiver; and
performing navigation for the in-store guiding route by using the wireless network signal receiver or the Bluetooth signal receiver.

7. (canceled)

8. The shopping guide method according to claim 1, further comprising:
capturing an object display area image according to the object location information; and
issuing a reminder notification if the needed object does not exist in the object display area image.

9. The shopping guide method according to claim 1, further comprising:
recording the object display area, the at least one region, the at least one display object and the positioning signal strength in the database.

10. The shopping guide method according to claim 9, further comprising:
updating the database according to the object display area image if there is a change in the object display area image.

11. A shopping guide platform, comprising:
a network transmission device, receiving object search information from a mobile device;
a database;
a search circuit, searching the database according to the object search information to determine a needed object, and obtaining object location information of the needed object according to the needed object;
a route circuit, obtaining object guiding information according to the object location information, wherein the object guiding information is a combination of an in-store guiding route and a store location guiding route, the store location guiding route is for guiding to an address of a store selling the needed object, and the in-store guiding route is for guiding to a region of an object display area where the needed object is located; and
an object management unit, recording a positioning signal strength corresponding to the needed object, wherein a processing unit of the mobile device measures a real-time signal strength of a wireless network signal receiver or a Bluetooth signal receiver and notifies that the region of the object display area where the needed object is located has been arrived if the real-time signal strength has reached the positioning signal strength corresponding to the needed object.

12. The shopping guide platform according to claim 11, wherein the object search information is an image or text.

13. The shopping guide platform according to claim 11, wherein the object search information is an image, at least one object image is separated from the image according to the object search information, and a selection instruction is received if a number of the at least one object image is greater than or equal to two.

14. (canceled)

15. (canceled)

16. The shopping guide platform according to claim 11, wherein the store location guiding route is used in a situation where the mobile device turns on a GPS receiver; the in-store guiding route is used in a situation where the mobile device turns on the wireless network signal receiver or the Bluetooth signal receiver.

17. (canceled)

18. The shopping guide platform according to claim 11, further comprising:
a visual unit, capturing an object display area image according to the object location information; and
an object management unit, issuing a reminder notification if the needed object does not exist in the object display area image.

19. The shopping guide platform according to claim 11, further comprising:
a positioning signal measurement unit, measuring a positioning signal strength, wherein the object management unit records the object display area, the at least one region, the at least one display object and the positioning signal strength in the database.

20. The shopping guide platform according to claim 19, wherein the object management unit updates the database according to the object display area image if there is a change in the object display area image.
